(19) United States
(12) Patent Application Publication
(10) Pub. No.: US 2026/0229420 A1
(43) Pub. Date: Aug. 6, 2026

(54) MULTI-SWITCH CONNECTOR FOR CONNECTING MULTIPLE BREAKER SWITCHES

(71) Applicant: Schneider Electric USA, Inc., Boston, MA (US)

(72) Inventors: Azucena Megchun Castillo, Nuevo León (MX); Carlos Alberto Gutierrez Ordonez, Nuevo Leon (MX); Ricardo Nicanor Palmer, Nuevo Leon (MX); Mariana Guevara Montiel, Nuevo Leon (MX)

(21) Appl. No.: 19/041,474

(22) Filed: Jan. 30, 2025

(51) Int. Cl. H01H 9/26; H01H 11/00

(52) U.S. Cl. CPC H01H 9/26; H01H 11/0006

(57) ABSTRACT

The embodiments described herein include a multi-switch connector configured to form a single unified switch from multiple breaker switches on a switch panel. The multi-switch connector is designed to be slidably attached to the switch panel such that a user may concurrently flip each breaker switch with a single motion. The embodiments also describe a kit including the multi-switch connector and other components for retrofitting a switch panel with the multi-switch connector using a plurality of fasteners. The kit is preferentially used according to a method which is also disclosed herein.

### FIELD

The present disclosure relates generally to a multi-switch connector for connecting two or more breaker switches on a panel.

### BACKGROUND

Service panels including circuit breakers or breaker switches are frequently used in both commercial and residential structures as a way to control the distribution of electrical power. They also cut power in the event of a power surge. For example, branch circuit breakers may control power delivery to a specific floor, room, or appliance. The service panel also includes primary breaker switches for controlling the flow of power through the circuit breaker and the structure altogether. These service panels are typically located inside the structure. In another application, primary breaker switches are located outside the structure where local codes require the ability to disconnect power to the structure from outside the structure. These primary circuit breaker switches may be part of a device called a meter main, which in some cases, includes a combination of a disconnect panel with the primary breaker switches and a meter socket for an electrical meter.

Some switch panels (e.g., service panels or meter main panels) include two or more primary breaker switches, also known as disconnect breaker switches. In these instances, more than one breaker switch must be flipped (i.e., toggled) in order to enable/disable main power delivery to the structure. This can pose a safety risk by increasing the time and/or effort needed to disable power to the structure when an immediate cessation of power is needed (e.g., in the case of a flood, in case someone is being electrocuted, etc.). Additionally, changes in the electrical code have recently mandated a single primary breaker switch in certain instances wherein multiple primary switches have previously been permitted.

### SUMMARY

In one aspect of the present disclosure, a multi-switch connector is disclosed. The multi-switch connector is configured for connecting first and second disconnect breaker switches which toggle between on and off positions on a switch panel. The multi-switch connector generally comprises a connector portion and a slide portion. The connector portion extends along a connector axis and defines a first switch opening and a second switch opening spaced apart along the connector axis. The first switch opening and second switch opening are configured to receive the first and second disconnect breaker switches, respectively. The slide portion extends laterally outward from the connector portion and is joined thereto. The slide portion defines at least one elongate channel configured to receive at least one fastener to slidably fasten the multi-switch connector to the switch panel.

In another aspect of the present disclosure, a kit is disclosed. The kit is configured to be retrofitted onto a switch panel for unifying at least two disconnect breaker switches which toggle along a switch direction. The kit general comprises a multi-switch connector and a plurality of fasteners configured to slidably attach the multi-switch connector to the switch panel. The multi- switch connector generally comprises a connector portion and a slide portion. The connector portion extends along a connector axis and defines a first switch opening and a second switch opening spaced apart along the connector axis. The first switch opening and second switch opening are configured to receive first and second disconnect breaker switches, respectively. The slide portion extends laterally outward from the connector portion and is joined thereto. The slide portion defines at least one elongate channel configured to receive at least one fastener to slidably fasten the multi-switch connector to the switch panel.

In yet another aspect of the present disclosure, a method of unifying two or more disconnect breaker switches on a switch panel is disclosed wherein each of the disconnect breaker switches are configured to toggle along a switch direction. The method includes drilling a plurality of holes in the switch panel, locating a multi-switch connector on the switch panel, and fastening the multi-switch connector to the switch panel using a plurality of fasteners. The multi-switch connector generally comprises a connector portion and a slide portion. The connector portion extends along a connector axis, the connector portion defining a first switch opening and a second switch opening spaced apart along the connector axis. The first switch opening and second switch opening are configured to receive first and second disconnect breaker switches, respectively. The slide portion extends from the connector portion and is joined thereto, the slide portion defining at least one elongate channel. Locating the multi-switch connector on the switch panel includes locating the first disconnect breaker switch in the first switch opening and locating the second disconnect breaker switch in the second switch opening.

Other objects and features of the present invention will be in part apparent and in part pointed out herein.

### BRIEF DESCRIPTION OF THE DRAWINGS

FIG. 1 is a perspective view of one embodiment of a multi-switch connector.

FIG. 2A is a front elevation of the multi-switch connector.

FIG. 2B is a rear elevation of the multi-switch connector.

FIG. 3 is a front elevation of one embodiment of a kit including the multi-switch connector.

FIG. 4 is a perspective view of a combo meter base/disconnect panel, including the multi-switch connector coupled to two disconnect breaker switches.

FIG. 5A is a front elevation of FIG. 4, with the two disconnect breaker switches in an "OFF" position.

FIG. 5B is similar to FIG. 5A, with the two disconnect breaker switches in an "ON" position.

FIG. 6 is a flow chart representing a method according to an embodiment.

### DETAILED DESCRIPTION

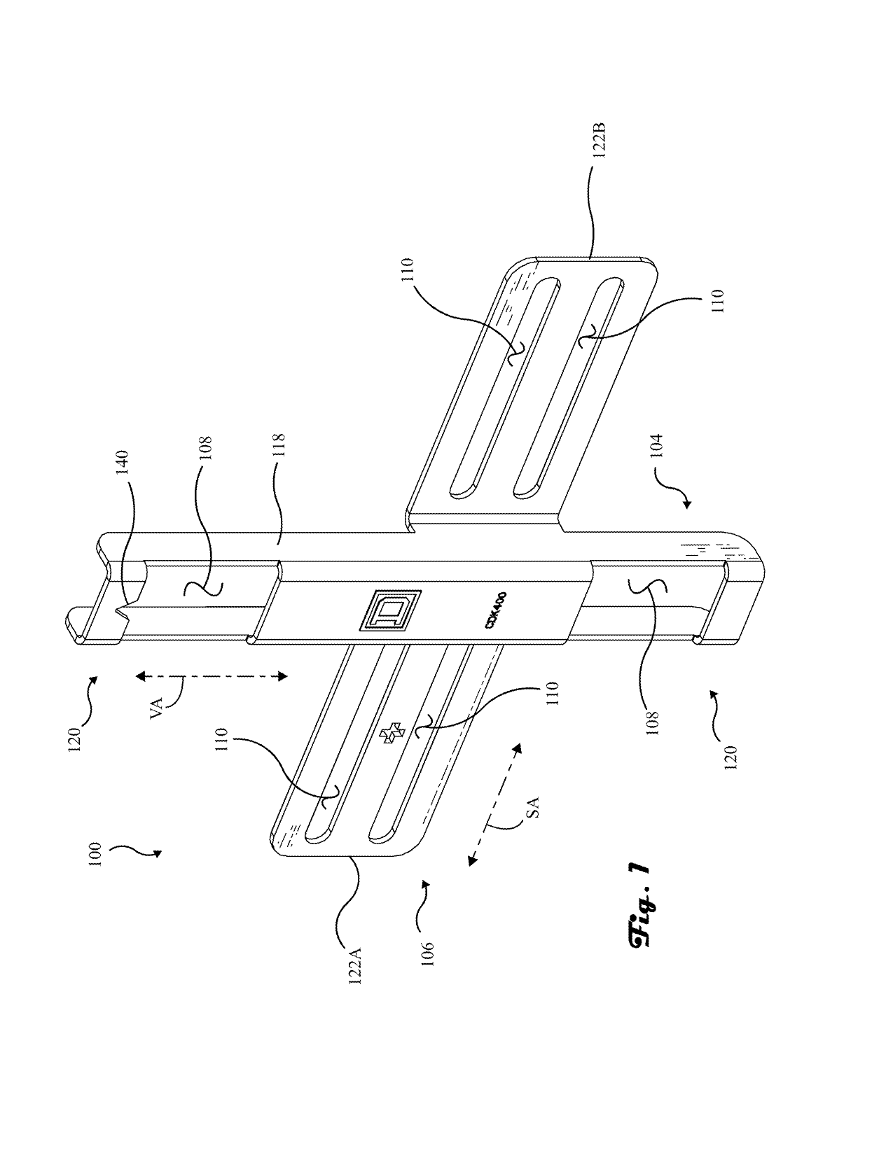

Referring briefly to FIGS. 1-6, an overview of the systems and methods disclosed below will be provided. The following disclosure describes a multi-switch connector and methods for unifying two or more breaker switches, such as disconnect breaker switches on a switch panel. The term "unifying" within the context of this disclosure refers generally to connecting multiple breaker switches with the multi-switch connector such that movement of the multi-switch connector enables concurrent flipping or toggling of the connected breaker switches between "ON" and "OFF" positions. In effect, the two connected breaker switches may be referred to as a "unified switch."

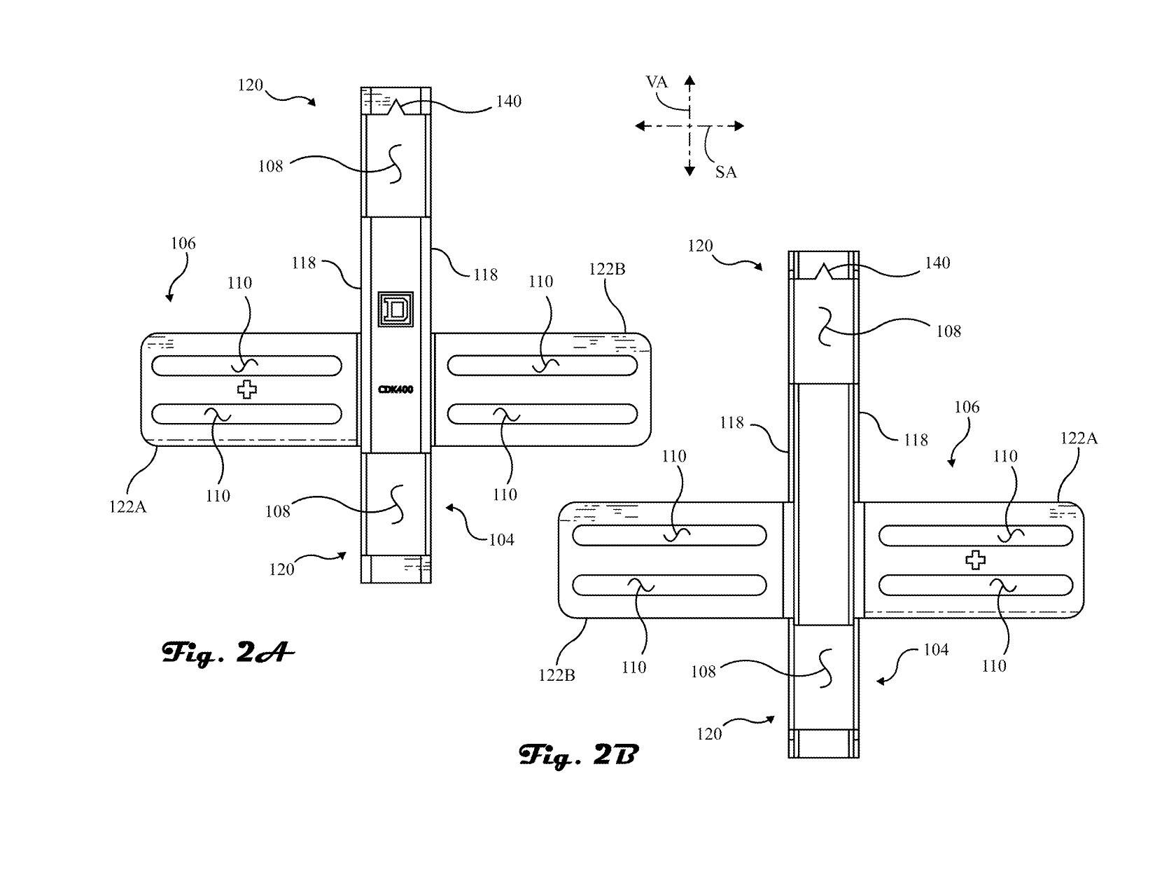

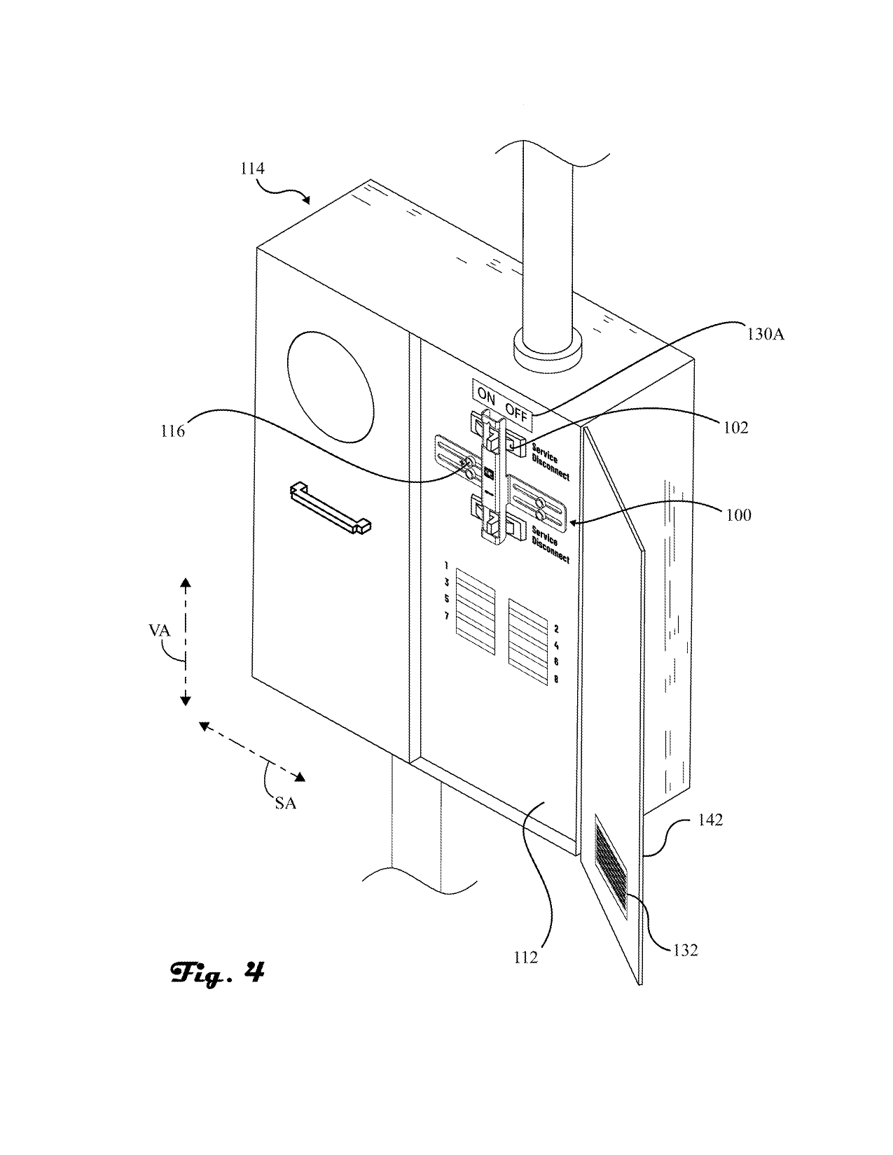

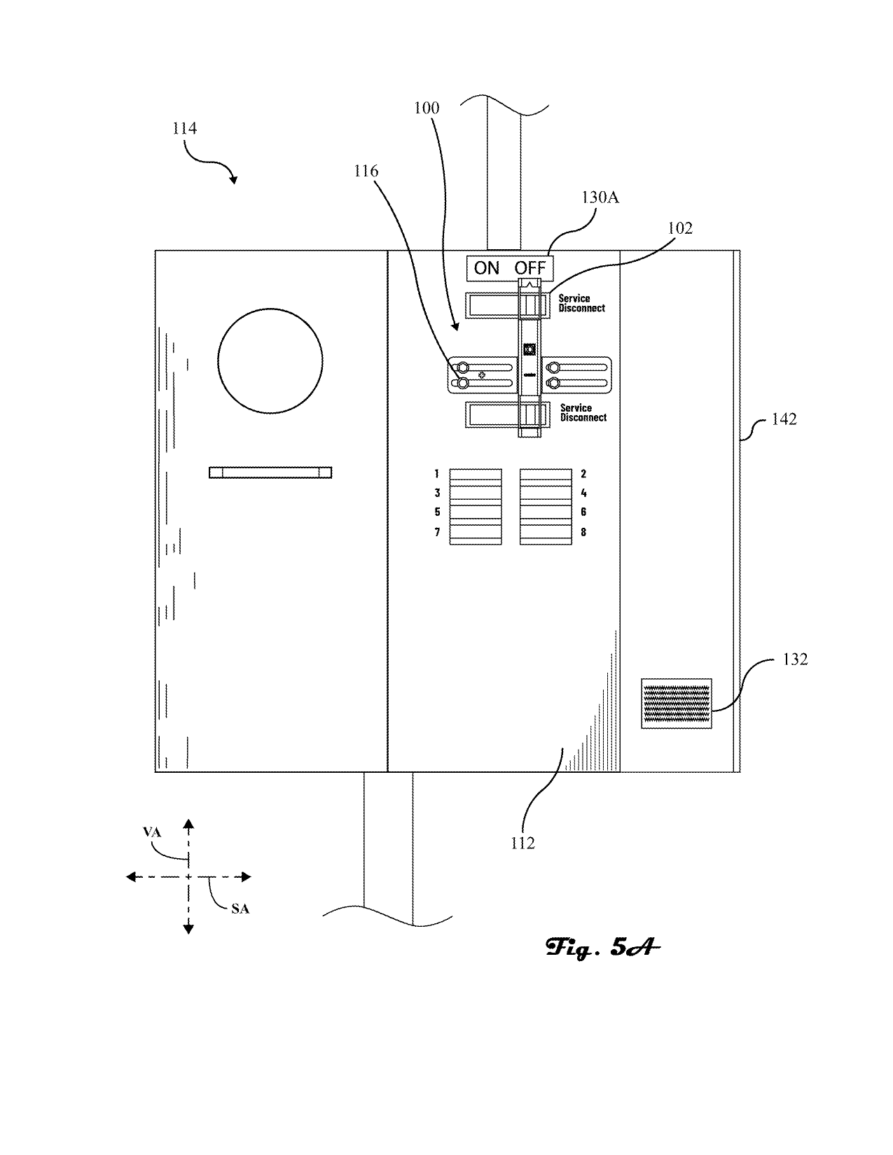

Referring to FIGS. 1-2A, one embodiment of a multi-switch connector, generally indicated at reference numeral 100, is configured to unify multiple breaker switches 102. The multi-switch connector 100 generally comprises a connector portion 104 which extends along a vertical axis VA (the vertical axis may hereinafter be referred to as the connector axis), and a slide portion 106 which extends laterally outwardly from the connector portion 104. The connector portion 104 has switch openings 108 which receive the breaker switches 102 (e.g., disconnect breaker switches as shown in FIGS. 4-SB). The slide portion 106 defines at least one elongate channel 110. The multi-switch connector 100 may be fastened to a switch panel 112 of an electrical device (e.g., meter main 114) using a plurality of fasteners 116 received in the elongate channel 110, allowing the multi-switch connector to slide along the direction of the channel in a switch direction SA (e.g., a horizontal axis) that is generally transverse to the vertical axis VA.

The connector portion 104 unifies the multiple breaker switches 102 to form a single unified switch. While the illustrated embodiment includes two breaker switches 102, the multi-switch connector 100 may be used with any number of spaced apart breaker switches. The connector portion 104 is the portion of the multi-switch connector 100 which an operator may preferentially press or push when using the multi-switch connector 100 to flip or toggle the unified switch. An operator may place their hand on one of two side regions 118 of the connector portion 104 and press left or right to flip the unified switch in the direction of the applied pressure (e.g., along the switch direction SA).

The connector portion 104 has a height along the vertical axis VA. In the illustrated embodiment (for example, at FIG. 4), the vertical axis VA is perpendicular to the switch direction SA. At opposing end regions 120, the connector portion 104 defines the switch openings 108 for receiving the breaker switches 102. In the illustrated embodiment, the height of the connector portion 104 is slightly greater than the distance between the two breaker switches 102, which are also spaced apart along the vertical axis VA, and the switch openings 108 are first and second switch openings for receiving corresponding first and second breaker switches 102.

Still referring to FIGS. 1-2A, the slide portion 106 functions as the site at which the multi-switch connector 100 is connected to the switch panel 112. In the illustrated embodiment, the slide portion 106 is a two-part slide portion having individual slide arms 122 (e.g., a first slide arm 122A and a second slide arm 122B). Each slide arm 122 extends laterally from the connector portion 104 at the side regions 118.

In the illustrated embodiment, the slide portion 106 defines four individual elongate channels 110 split evenly among the slide arms 122. Each slide arm 122 has two elongate channels 110, and each elongate channel 110 has a length extending along the switch direction SA. The elongate channels 110 are spaced apart vertically along the vertical axis VA at each of the two slide arms 122. The multi-switch connector 100 is connected to the switch panel 112 using a plurality of fasteners 116 which extend through the elongate channels 110, allowing movement (e.g., sliding) of the multi-switch connector 100 along the switch direction SA.

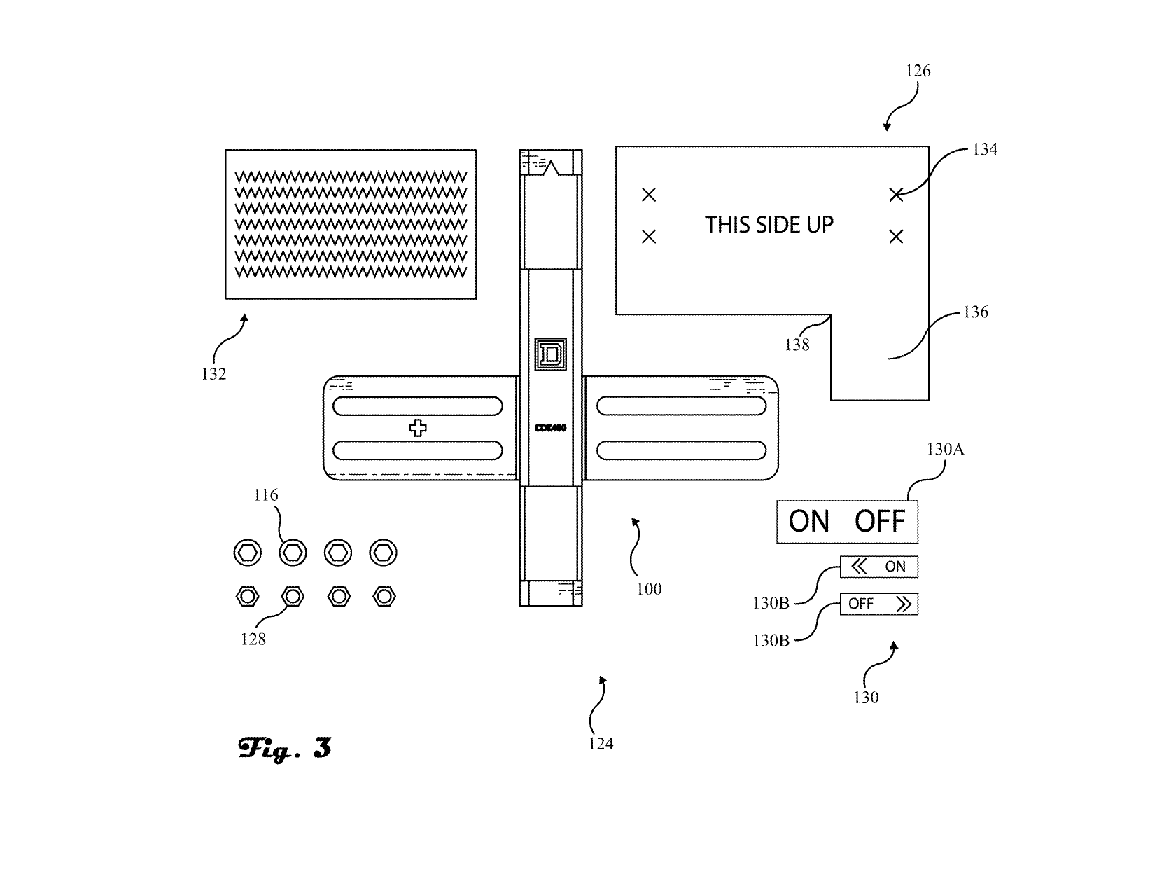

The illustrated multi-switch connector 100 is part of a kit 124 (FIG. 3). The kit 124 includes items and instructions necessary for an operator to retrofit the multi-switch connector 100 onto an existing switch panel 112, such that a switch panel having multiple primary breaker switches 102 can be made to have one unified switch. In the illustrated embodiments shown in FIGS. 4-SB, the switch panel 112 part of the meter main 114.

The kit 124 of the present embodiment enables a single unified switch to be created without the need to replace the meter main 114 or parts thereof (e.g., the switch panel 112), or to perform complicated operations to modify the meter main 114. Section 230.71 of the National Electrical Code (NEC) reads in part "[e]ach service shall have only one disconnecting means unless the requirements of 230.71(B) are met." Below is description of a system and methods, according to an embodiment of the present invention, which facilitate the unification of multiple primary breaker switches 102.

Referring to FIGS. 3-SB, a kit 124 according to an embodiment of the present invention is disclosed. The kit 124 is shown uninstalled at FIG. 3 and installed at FIGS. 4-SB. Note that FIGS. 3-SB are not exhaustive representations of the disclosed kit 124, and do not therefore include each and every element of the disclosed kit 124.

The kit 124 of the present disclosure, according to an embodiment shown at FIGS. 3-SB, generally comprises: installation instructions (not shown); the multi-switch connector 100; a drill hole guide 126; the plurality of fasteners 116 (e.g., bolts with corresponding nuts 128); a switch state label 130; and an accessory label 132.

The installation instructions are included to convey information about methods of installation for the disclosed kit 124, such as described below.

The multi-switch connector 100 according to FIG. 3 is the same multi-switch connector shown in FIGS. 1-2B and described in detail above.

The drill hold guide 126 is a planar element configured to be placed on the switch panel 112, and has a plurality of drill hole indications 134 distributed thereon for indicating where a user should drill into the switch panel 112. Each of the drill hole indications 134 are spaced apart specifically so that the drill holes in the switch panel 112 align with the four independent elongate channels 110 defined by the slide arms 122 of the slide portion 106. The drill hole guide 126 has an alignment arm 136 which aligns the drill hole guide 126 with the breaker switches 102 in order to ensure that the first and second breaker switches 102 are receivable into the first and second switch openings 108, respectively, when the multi-switch connecter 100 is installed. In the illustrated embodiment, the drill hole guide 126 has an alignment corner 138 for receiving a breaker switch 102.

The fasteners 116 are used to attach the multi-switch connector 100 to the switch panel 112. In the illustrated embodiment, the fasteners 116 are bolts and thread into corresponding nuts 128. Each bolt 116 is inserted through both the elongate channel 110 and a drill hole in the switch panel 112 and secured via its corresponding nut 128 on a rear side of the switch panel 112. In certain embodiments, the nuts 128 are lock nuts. Each bolt-nut pair is configured to hold the multi-switch connector 100 securely on the switch panel 112 without impeding its longitudinal movement along the switch direction SA.

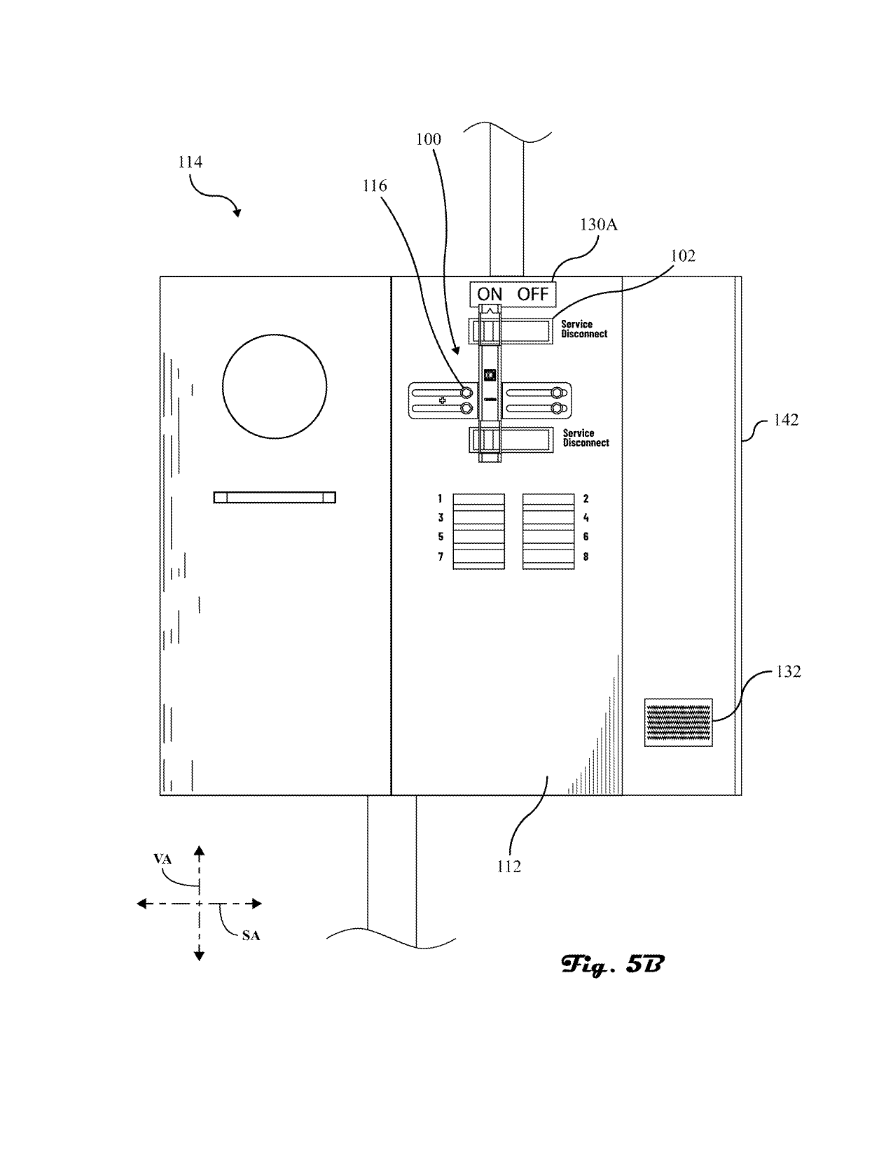

The switch state label 130 facilitates the rapid identification of a current switch state (e.g., open circuit vs closed circuit or ON vs OFF), as well as which direction (e.g., left vs right) will result in a given switch state. FIG. 3 shows a panel-mounted switch state label 130A for being adhered to the switch panel 112, as well as two connector-mounted switch state labels 130B for being adhered to the multi-switch connector 100. The connector-mounted switch state labels 130B may be located on opposite slide arms 122. The panel-mounted switch state label 130A is configured to work in conjunction with a switch state indicator 140 to assist an operator in recognizing the state of the unified switch. This is shown in FIGS. 5A and SB, which show the unified switch at an OFF state (open circuit) and an ON state (closed circuit state), respectively. The switch state indicator 140 points to a portion of the panel-mounted switch state label 130A (e.g., a first portion or a second portion) which corresponds to a specific switch state. While the switch state indicator 140 is at an end region 120 of the connector portion 104 of the multi-switch connector 100, it may be located anywhere on the multi-switch connector which facilitates its use with the panel-mounted switch state label 130A.

The accessory label 132 includes information relevant to the multi-switch connector 100 or kit 124 which may be useful to include on or near the breaker switches 102 (e.g., the model or part number of the multi-switch connector 100, instructions on how to use the multi- switch connector 100, who to contact in the event of a malfunction, etc.). In the illustrated embodiment, the accessory label 132 is on a door 142 of the meter main 114.

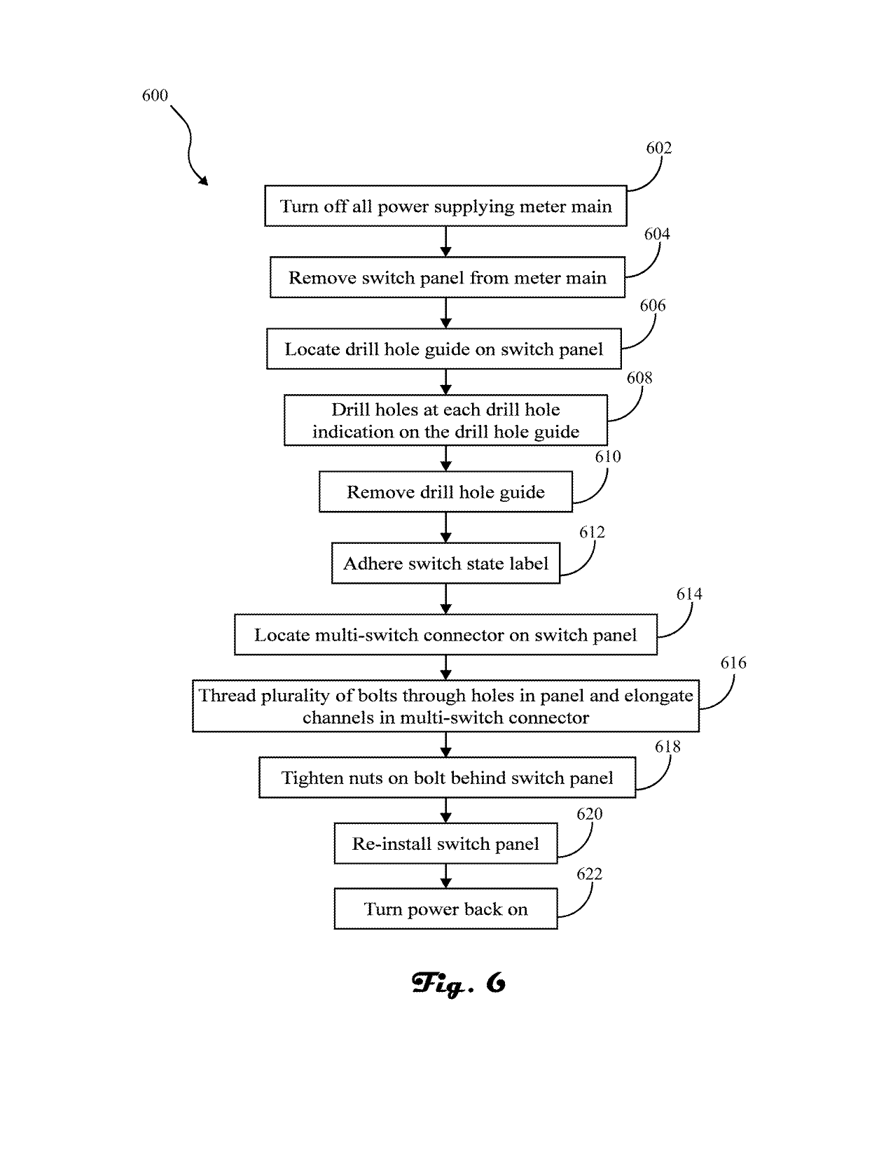

Referring now to FIG. 6, a method 600 of unifying multiple breaker switches 102 according to an embodiment is disclosed. The illustrated method is directed in particular toward the installation of the kit 124 described above and depicted in FIG. 3.

At step 602, all power to the meter main 114 is turned off. This step ensures the safety of an installer which may be installing the kit 124 by reducing the risk of electrocution.

At step 604, the switch panel 112 is removed from the meter main 114. In most meter mains 114, the switch panel 112 is removable, making this step quite simple to perform. By removing the switch panel 112 from the meter main 114, the rear side of the switch panel 112 is made accessible, which may be necessary for other steps. Additionally, this further mitigates the risk of electrocution by isolating a working environment from the rest of the meter main 114 and therefore minimizing the time spent at/near/on the meter main 114. Step 604 may require the removal of fasteners which hold the switch panel 112 in place (not shown).

At step 606, the drill hole guide 126 is located on the switch panel 112. Locating the drill hole guide 126 may include aligning the drill hole guide 126 by receiving the breaker switch 102 into the alignment corner 138. By doing so, each of the drill hole indications 134 indicated on the drill hole guide 126 will be located such that, after installation, the multi-switch connector 100 is properly aligned and therefore receives each breaker switch 102 into their respective switch openings 108 on the connector portion 104. In order to prevent the drill hole guide 126 from shifting, it may be taped to the switch panel 112. The drill hole guide 126 may also include an adhesive such that the drill hole guide 126 is, in effect, a sticker.

At step 608, holes are drilled into the switch panel 112 at each of the drill hole indications 134 located on the drill hole guide 126. At this step, an operator may locate a drill bit connected to a drill at each of the drill hole indications 134 and drill through both the drill hole guide 126 and the switch panel 112 located therebehind.

At step 610, the drill hole guide 126 is removed from the switch panel 112.

At step 612, the switch state label 130 is adhered. If the switch state label 130 is a panel-mounted switch state label 130A, adhering the switch state label 130 includes locating it in proximity to the anticipated location of the switch state indicator 140 on the multi-switch connector 100 such that the switch state indicator 140 points to the portion of the panel-mounted switch state label 130A which properly represents the switch state (e.g., OFF when the unified switch is in the off position and ON when the unified switch is in the on position). If the switch state label 130 is a connector-mounted switch state label 130B, adhering the switch state label 130 includes two separate labels as illustrated. In this instance, the connector-mounted switch state labels 130B should point in the correct direction for indicating the switch state. For example, if an "OFF" switch state is achieved by sliding the multi-switch connector 100 to the left, the "OFF" connector- mounted switch state label 130B should be adhered on the leftmost (e.g., first) slide arm 122A. In this instance, the "ON" connector-mounted switch state label 130B should therefore be located on the rightmost (e.g., second) slide arm 122B. The connector-mounted switch state labels 130B and the panel-mounted switch state label 130A may both be included in the installation.

At step 614, the multi-switch connector 100 is located on the switch panel 112. This includes lining up each of the elongate channels 110 with their corresponding holes in the switch panel 112. By locating the multi-switch connector 100 in this way, it is prepared to receive the plurality of fasteners 116. In this embodiment, the fasteners 116 are bolts with the corresponding nuts 128.

At step 616, the bolts 116 are threaded through the holes in the switch panel 112 and the elongate channels 110 in the multi-switch connector 100. If step 614 is completed properly, then step 616 comprises pushing a bolt 116 through each of the holes in the switch panel 112 while maintaining the multi-switch connector 100 at its position thereon.

At step 618, the nuts 128 are located on the bolts 116 on the rear side of the switch panel 112 and tightened. As previously mentioned, this step should be performed such that the bolt-nut pairs are tight enough to hold the multi-switch connector 100, but not tight enough to prevent longitudinal (e.g., left/right) movement (e.g., sliding) along the switch direction SA.

At step 620, the switch panel 112 is re-installed onto the meter main 114. If fasteners were removed during the removal of the switch panel 112, such fasteners should be refastened.

At step 622, electrical power to the meter main 114 is turned back on.

While the system and method has been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles "a," "an," "the," and "said" are intended to mean that there are one or more of the elements. The terms "comprising," "including," and "having" are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A multi-switch connector for connecting first and second disconnect breaker switches which toggle between on and off positions on a switch panel, comprising:
a connector portion extending along a connector axis, the connector portion defining a first switch opening and a second switch opening spaced apart along the connector axis, the first switch opening and second switch opening being configured to receive the first and second disconnect breaker switches, respectively; and
a slide portion extending laterally outward from the connector portion and joined thereto, the slide portion defining at least one elongate channel configured to receive at least one fastener to slidably fasten the multi-switch connector to the switch panel.

2. The multi-switch connector of claim 1, wherein the at least one elongate channel has a length extending transversely relative to the connector axis.

3. The multi-switch connector of claim 2, wherein the slide portion comprises first and second slide arms extending laterally from the connector portion on opposite side regions thereof.

4. The multi-switch connector of claim 3, in combination with the first and second disconnect breaker switches on the switch panel.

5. The multi-switch connector of claim 4, further comprising a plurality of fasteners,
wherein the at least one elongate channel includes a plurality of elongate channels, wherein the multi-switch connector is retained on the switch panel by the plurality of fasteners, the plurality of fasteners extending through the plurality of elongate channels, wherein the first disconnect breaker switch is retained in the first switch opening and the second disconnect breaker switch is retained in the second switch opening.

6. The multi-switch connector of claim 5, wherein the multi-switch connector is slidable along a switch direction extending transversely relative to the connector axis such that an operator may concurrently flip each of the first disconnect breaker switch and the second disconnect breaker switch in a single motion by sliding the multi-switch connector along the switch direction.

7. The multi-switch connector of claim 3, wherein each of the first slide arm and second slide arm includes two of the elongate channels spaced apart a distance along the connector axis.

8. The multi-switch connector of claim 1, wherein the multi-switch connector is a single sheet of metal.

9. A kit for being retrofitted onto a switch panel and for unifying at least two disconnect breaker switches which toggle along a switch direction, comprising:
a multi-switch connector comprising:
a connector portion extending along a connector axis, the connector portion defining a first switch opening and a second switch opening spaced apart along the connector axis, the first switch opening and second switch opening being configured to receive first and second disconnect breaker switches, respectively;
a slide portion extending laterally outward from the connector portion and joined thereto, the slide portion defining at least one elongate channel configured to receive at least one fastener to slidably fasten the multi-switch connector to the switch panel; and
a plurality of fasteners configured to slidably attach the multi-switch connector to the switch panel.

10. The kit of claim 9, wherein the at least one elongate channel has a length extending in the switch direction.

11. The kit of claim 10, wherein the slide portion comprises first and second slide arms extending outwardly from the connector portion on opposite side regions thereof.

12. The kit of claim 9, further comprising a hole drilling template for indicating a plurality of drill hole indications on the switch panel.

13. The kit of claim 9, further comprising:a switch state label configured to be adhered to the switch panel; and a switch state indicator on the multi-switch connector;

14. The kit of claim 13, wherein the switch state label comprises a first labeled portion indicating a closed circuit state and a second labeled portion indicating an open circuit state, and wherein the switch state indicator is configured to point to the first labeled portion whenever the disconnect breaker switches form a closed circuit state and wherein the switch state indicator is configured to point to the second labeled portion whenever the disconnect breaker switches form an open circuit state.

15. A method of unifying two or more disconnect breaker switches on a switch panel, each of the disconnect breaker switches being configured to toggle along a switch direction, the method comprising:
drilling a plurality of holes in the switch panel;
locating a multi-switch connector on the switch panel, the multi-switch connector comprising:
a connector portion extending along a connector axis, the connector portion defining a first switch opening and a second switch opening spaced apart along the connector axis, the first switch opening and second switch opening being configured to receive first and second disconnect breaker switches, respectively; and
a slide portion extending from the connector portion and joined thereto, the slide portion defining at least one elongate channel; and
fastening the multi-switch connector to the switch panel using a plurality of fasteners,
wherein locating the multi-switch connector on the switch panel includes locating the first disconnect breaker switch in the first switch opening and locating the second disconnect breaker switch in the second switch opening.

16. The method of claim 15, wherein locating the multi-switch connector on the switch panel further includes aligning at least a portion of the plurality of holes with the at least one elongate channel.

17. The method of claim 16, wherein the plurality of fasteners comprises a plurality of bolts and a plurality of locking nuts, and wherein fastening the multi-switch connector to the switch panel includes threading the plurality of bolts through the aligned plurality of holes and at least one elongate channel and attaching the plurality of locking nuts to the plurality of bolts.

18. The method of claim 15, further comprising adhering a switch state label to the switch panel, the switch state label comprising a first labeled portion indicating a closed circuit state and a second labeled portion indicating an open circuit state.

19. The method of claim 18, wherein the multi-switch connector further comprises a switch state indicator, and wherein adhering the switch state label to the switch panel comprises locating the switch state label in proximity to the switch state indicator such that the switch state indicator points to the first labeled portion whenever the disconnect breaker switches form a closed
circuit state and points to the second labeled portion whenever the disconnect breaker switches form an open circuit state.

20. The method of claim 15, wherein drilling the plurality of holes in the switch panel comprises locating a hole drilling template on the switch panel and drilling through a plurality of drill hole indications on the hole drilling template.
Confidential
